(19) United States
(12) Patent Application Publication
(10) Pub. No.: US 2024/0051420 A1
(43) Pub. Date: Feb. 15, 2024

(54) METHOD FOR CARRYING OUT A CHARGING PROCESS USING AN ENERGY STORE OF A MOTOR VEHICLE AND CHARGING SYSTEM

(71) Applicant: AUDI AG, Ingolstadt (DE)

(72) Inventor: Ansgar NEUDECKER, Greding (DE)

(73) Assignee: AUDI AG, Ingolstadt (DE)

(21) Appl. No.: 18/366,751

(22) Filed: Aug. 8, 2023

(30) Foreign Application Priority Data
Aug. 12, 2022 (DE) 102022120438.3

(51) Int. Cl. B60L 53/62; B60L 58/24

(52) U.S. Cl. CPC B60L 53/62; B60L 58/24; B60L 2240/80

(57) ABSTRACT

A method for carrying out a charging process using an energy store of a motor vehicle. The motor vehicle can be connected to an intermediate store coupled to an energy source in order to carry out the charging process. A relationship between at least one situation parameter, a charging power and an efficiency of the charging process is provided, a value of the situation parameter is determined, and at least if the charging process is to be carried out using the intermediate store according to a predetermined criterion, the charging process is carried out.

### FIELD

The invention relates to a method for carrying out a charging process using an energy store of a motor vehicle, wherein the motor vehicle is able to be connected to an intermediate store coupled to an energy source and/or to an energy sink in order to carry out the charging process.

Furthermore, the invention also relates to a charging system.

### BACKGROUND

When charging battery electric vehicles (BEV), a rough distinction is made between two modes: immediate “ad hoc” charging and planned or also intelligent or smart charging. The possible uses of the vehicle battery also result in different options for charging including unidirectional and bidirectional charging. Unidirectional charging is usually associated with feeding energy into the vehicle battery with the aim of generating range from it. Bidirectional charging is an extension consisting in “the direction out of the vehicle”, so that the vehicle battery is used, for example, to operate external consumers, also known as vehicle-to-load or V2L, to operate homes or home consumers, also known as vehicle-to-home or V2H, or to feed energy into the grid, which is also known as vehicle-to-grid or V2G.

Charging can also take place with different charging powers. This depends in particular on the charging power that can be made available by the energy source from which energy is obtained, for example a charging station. When charging at a household socket, the AC (alternating current) charging power is typically 2.3 kilowatts, while a wall box can be charged with eleven kilowatts or possibly 22 kilowatts, and at public charging stations, especially at fast charging stations, sometimes with significantly higher DC (direct current) charging power, for example also over 100 kilowatts. Most charging strategies aim to charge as quickly as possible. However, the highest possible efficiency would also be very desirable.

CN 212195139 U describes a direct current high-power charging station. The charging station has a solar panel and a storage battery. This allows a high charging power to be provided.

### SUMMARY

The object of the present invention is to provide a method and a charging system that allow a charging process to be carried out as efficiently as possible.

The invention relates to a method for carrying out a charging process using an energy store in a motor vehicle, the motor vehicle being able to be connected to an intermediate store coupled to an energy source and/or to an energy sink in order to carry out the charging process. A relationship between at least one situation parameter, a charging power and an efficiency of the charging process is provided and a value of the situation parameter is determined. Furthermore, it is determined whether a charging process is to be carried out using the intermediate store according to a predetermined criterion, and at least if the charging process is to be carried out using the intermediate store according to the predetermined criterion, the charging process is carried out, in which electrical energy is transmitted between the intermediate store and the energy store of the motor vehicle with the charging power according to a first charging power value, which was determined as a function of the specific value of the situation parameter and the relationship, for optimizing the efficiency.

The invention is based on the finding that the efficiency of a charging process, in particular its efficiency, depends on various influencing factors and is also significantly influenced by the charging power. For example, the efficiency generally decreases with the charging power, among other things due to the self-consumption of consumers required for charging. If, for example, charging is carried out at a fast-charging station with a very high charging power, the energy store usually has to be cooled very strongly during this time. A large part of the charged energy is therefore used to operate such consumers, such as cooling devices in the motor vehicle for cooling the energy store, which on the one hand extremely reduces the charging efficiency, since a large proportion of the charged and paid energy does not increase the range of the motor vehicle, and on the other hand this in turn protracts the charging process, which enormously reduces the actual advantage of fast charging stations. However, too low a charging power can also lead to very large energy losses, which in turn can depend on the specific design of a motor vehicle. Different motor vehicles can be designed for different charging powers for optimizing their efficiency. When designing battery electric vehicles with regard to charging, the efficiency is usually optimized in relation to relevant approval conditions. These usually differ from each other depending on the market. Typical for the European Union is an optimization to eleven kilowatts of AC (alternating current) charging, in China to 7.2 kilowatts of AC charging and in the USA to 9.6 kilowatts of AC charging. Depending on the vehicle, optimizations for other charging powers such as 350 kilowatts DC (direct current) can also be preferred. In practice, however, there are sometimes significant deviations from this preset optimum. If charging is carried out with a different charging power than that for which the vehicle is optimized, the efficiency of one and the same vehicle can differ by up to 25 percent. There are also numerous other influencing factors that influence the efficiency of a charging process, such as the type of current flow, namely whether direct current or alternating current is used for charging, the outside temperature, the battery temperature of the energy store, and so on. While the effects on charging efficiency cannot be significantly influenced in many situations, there are considerable opportunities in a self-sufficient ecosystem of vehicle and battery storage, namely in the combination of the vehicle's energy store and an intermediate storage coupled to an energy source. This in turn makes it possible to select charging powers very flexibly and freely for the charging process to be carried out. The charging powers that can be used are then, for example, independent of the powers that can be provided directly by the energy source. If, instead, a motor vehicle with its energy store is connected directly to an energy source without intermediate storage, for example to a household socket, to a wall box or to a charging station, the charging power values that can be used for charging are usually fixed and cannot be flexibly selected. So there is no possibility of optimization with regard to the efficiency of the charging process. The possibility of connecting the motor vehicle to an intermediate store for charging purposes means that, on the one hand, significantly more flexibility can be provided with regard to the selection of a suitable charging power for carrying out the charging process, and this in turn allows, on the other hand, due to the relationship provided between at least one situation parameter, the charging power and the efficiency, to select a charging power that allows the charging process to be carried out in a particularly efficiency-optimized manner in a given situation. In other words, depending on the current situation parameter, a charging power, more precisely a charging power value, can be selected for which the efficiency of the charging process to be carried out is as high as possible or is maximum according to the relationship provided. As a result, a charging process can be carried out particularly energy-efficiently overall and the power loss can be reduced to a minimum. This results in a significant cost advantage for the user of the motor vehicle, since the same amount of energy fed into the motor vehicle now leads to a greater range, since there are fewer losses. Also in the case of bidirectional charging, if, for example, the energy sink, such as a household or a home consumer, is to be supplied with energy from the energy store, the same or similar advantages result very similarly, because the energy supply of the energy sink can be temporally decoupled from the provision of energy by the energy store through the intermediate store, and here again a charging power, with which energy from the energy store is supplied to the intermediate store, can be selected in an efficiency-optimized manner based on the provided relationship and depending on the situation parameter, since the charging power can be chosen independently of the supplied power that is required by the energy sink. In addition, there are also significant benefits in relation to other load and design factors of the vehicle. For example, the design of the vehicles can be optimized with regard to the discharge time for bidirectional charging, namely through higher discharge powers in the intermediate store the discharge time is decoupled from the actual provision of energy, since this is now taken over by the intermediate store. Thus, for example, the number of wake-up cycles of the motor vehicle can also be reduced as a function of the storage size of the intermediate store, as will be explained in more detail later.

A charging process using the energy store of the motor vehicle can be a charging process in which the energy store of the motor vehicle is charged or discharged, at least in part. The energy store of the motor vehicle can be designed, for example, as a battery, in particular as a high-voltage battery. This battery can have numerous battery cells, for example lithium-ion cells. The energy store of the motor vehicle can have a capacity of 50 kilowatt hours up to 100 kilowatt hours or more, for example. The intermediate store can also be designed as a battery, for example also as a high-voltage battery, but this is preferably provided as a stationary energy store. The intermediate store serves as a sort of buffer storage. It is therefore preferred that this has a smaller capacity than the energy store of the motor vehicle, for example a capacity in the range of eight to 15 kilowatt hours or more in one possible application. When carrying out the charging process, during which energy is transferred between the intermediate store and the energy store of the motor vehicle, additional energy can also be transferred from the energy source, which is coupled to the intermediate store, to the intermediate store and/or to the energy store of the motor vehicle, in particular at the same time. If, for example, the energy store is to be charged during the charging process, it can simultaneously draw energy from the intermediate store and from the energy source or the energy source can continue to supply the intermediate store with energy. If the intermediate store is electrically coupled to an energy sink, namely an electrical consumer, the intermediate store can supply the energy sink with energy while the intermediate store is being charged by the energy store. Theoretically, it is also possible here, albeit less preferred, for the energy sink to be simultaneously supplied with energy from the intermediate store and directly from the energy store. However, the energy sink can preferably only be supplied directly via the intermediate store. During the charging process, during which energy is transferred between the energy store and the intermediate store, the energy store is electrically connected to the intermediate store. The energy store can therefore be connected to the intermediate store beforehand.

The energy source is preferably a regenerative energy source, for example a photovoltaic system, which will sometimes also be referred to as a PV system. However, the provision of a wind turbine or the like is also conceivable. This is particularly advantageous since the extreme charging power fluctuations of the charging power that can be provided by such regenerative energy sources can advantageously be compensated for by the intermediate store. If, for example, only a small amount of power can be provided by the photovoltaic system on a cloudy day, the charging process can still be carried out with a significantly higher charging power through the additional use of the intermediate store. This in turn can be used to increase efficiency.

The relationship provided links the values of situation parameters, charging power and efficiency. The efficiency can also be taken into account indirectly via the charging power, for example in the form of an efficiency-optimized charging power. In other words, for example, for different values of the situation parameter, an efficiency-optimized charging power value can be indicated by the relationship, wherein the efficiency-optimized charging power value represents that charging power value for which the efficiency of the charging process to be carried out for the given situation parameter value, for example, exceeds a predetermined limit value and is preferably maximum. The relationship can be provided in a wide variety of forms, for example as a characteristic diagram, a table, a formula, a function or functional or the like. The relationship can also be adaptive and/or learnable and can be adapted and learned, for example, by a control device, which can be designed, for example, to carry out the method described. For example, for each charging process, this relationship can correlate the energy supplied to the relevant energy store, namely the motor vehicle energy store or the intermediate store, to the energy increase in this energy store that is caused by the charging process and corresponds to the increase in the state of charge, in order to determine the efficiency of the charging process, in particular in a situation characterized by the corresponding value of the at least one situation parameter. However, the relationship can also have been determined experimentally in advance and stored in a memory of such a control device.

The consideration of the at least one situation parameter is in turn based on the finding that the efficiency of a charging process depends not only on the charging power or the charging power value with which the charging process is carried out, but also on other influencing factors that can be taken into account in this situation parameter. One of these influencing factors is, for example, the temperature, in particular the vehicle temperature. Taking the situation parameter into account thus allows a significantly better adaptation to the situation, since a charging power value that leads to a very high efficiency in one situation does not automatically lead, in another situation, to a very high or the highest efficiency, which can instead be achieved by a different charging power value. At very high vehicle temperatures, for example, it can be better, in view of the efficiency of the charging process, to use a lower charging power for charging, for example in order to avoid or minimize the additional activation of cooling devices, in order to increase in turn the charging efficiency, while at very low temperatures a higher charging power can be selected, which allows higher efficiency to be achieved, since no additional cooling is required due to the low starting temperature. The charging efficiency can thus advantageously be optimized to suit the situation.

In an advantageous embodiment of the invention, the energy is transferred from the intermediate store to the energy store of the motor vehicle during the charging process, thus charging the energy store. This is particularly advantageous since it allows the energy store of the motor vehicle to be charged particularly efficiently. Since the efficiency of the method described is very high and can in particular be optimized, the energy charged from the intermediate store benefits the range of the motor vehicle to the maximum extent. As already mentioned above, during the charging process the energy can be transferred not only from the intermediate store to the energy store of the motor vehicle, but also simultaneously, for example, from the energy source to the energy store of the motor vehicle.

In an advantageous embodiment of the invention, the energy is transferred from the energy store to the intermediate store during the charging process, thus charging the intermediate store. This embodiment is very advantageous, in particular if the energy sink, such as other loads, is then to be supplied with energy via the intermediate store. The efficiency can thus also be increased and the charging efficiency maximized for bidirectional charging.

A further advantageous embodiment of the invention is that a consumer as an energy sink is coupled to the intermediate store and the consumer is charged with energy from the intermediate store. Here, too, it is conceivable that the consumer is optionally also fed directly with energy from the energy source. The consumer can be, for example, a home or a domestic consumer, or a consumer that is independent of a household, or a power grid into which energy is fed from the intermediate store. If, for example, a home consumer is supplied with energy from the intermediate store, this has the great advantage, in contrast to direct supply from the energy store of the motor vehicle, that the motor vehicle does not have to be woken up as often to provide the energy from the energy store. In other words, the intermediate store can instead provide energy to the consumer very flexibly every time this energy is requested by the consumer. The motor vehicle with the energy store can be woken up much less frequently in order to supply the intermediate store with energy from the energy store of the motor vehicle. The number of wake-up cycles, depending on the size of the intermediate store, can thus be reduced by the charging pulses. The larger the intermediate store, the less frequently it is necessary to wake up the motor vehicle with the energy store in order to load the intermediate store with energy from the motor vehicle or from its motor vehicle energy store. The duration of the charging process can be increased for this purpose. This is significantly gentler on the motor vehicle's energy store and increases its service life. In other words, the energy store of the motor vehicle can also be used for bidirectional charging without impairing its service life too much. In addition, the provision of energy from the energy store to the intermediate store can be linked to other factors or conditions. For example, this energy provision can only be possible as long as it is ensured that a certain amount of residual energy remains in the energy store of the motor vehicle. This can also be dependent on the next time of use of the motor vehicle, which can be specified for example by a user.

According to a further advantageous embodiment of the invention, the predetermined criterion, according to which it is checked whether a charging process is to be carried out using the intermediate store or only using the intermediate, comprises that a first efficiency value for the charging process to be carried out with direct coupling of the energy store to the energy source or the energy sink is determined as a function of at least one situation parameter, the relationship and in particular a second charging power value determined by the energy source or the energy sink and if this first efficiency value falls below a predetermined limit value, the predetermined criterion is considered to be met. In other words, a first efficiency value can be determined taking into account the situation parameter for a charging process with direct coupling of the energy store to the energy source, such as without the participation of the intermediate store. The second charging power value, which is determined by the energy source, is also taken into account when determining the efficiency value. If, for example, the energy source is a photovoltaic system, it can provide more or less charging power for charging the energy store, for example depending on the current position of the sun or degree of cloud cover. Depending on the charging power and the situation parameter, a first efficiency value is obtained for such a direct charging process at the energy source. If this efficiency value is, for example, equal to or greater than the predetermined limit value, the charging process, especially if it is a charging process for charging the energy store of the motor vehicle, can also be carried out without using the intermediate store or at least additionally be carried out by the energy source, namely by directly coupling the energy store to the energy source. In other words, in this case the energy store can alternatively or additionally be charged directly by the energy source. However, if the efficiency value for this direct charging process is very low or falls below the predetermined limit value, the predetermined criterion is considered to be met and the charging process is then carried out accordingly using the intermediate store and without direct coupling to the energy source. The direct charging process can also be used, for example, in the case of a high first efficiency value, in order to protect the intermediate store. In addition, the intermediate storage of energy in the intermediate store in turn results in certain losses, which can also be avoided in this way. Depending on the situation and especially with regard to the greatest possible charging efficiency, the charging process can thus advantageously be carried out using the intermediate store or without using the intermediate store and with or without direct coupling to the energy source. This also applies analogously to bidirectional charging and coupling to the energy sink.

However, the predetermined criterion can additionally or alternatively also be defined differently. For example, the predetermined criterion, according to which it is checked whether a charging process is to be carried out using the intermediate store or using only the intermediate store, can also include that a first efficiency value for the charging process to be carried out with direct coupling of the energy store to the energy source or the energy sink is determined as a function of at least one situation parameter, the relationship and in particular a charging power value determined by the energy source or the energy sink and is compared with a second efficiency value, which is associated to the charging process with the first determined charging power value by means of the intermediate store according to the relationship, and the predetermined criterion is considered to be met when the first efficiency value is less than the second efficiency value by a predetermined minimum value. The predetermined minimum value can also be zero. In particular, the predetermined minimum value is positively defined. In other words, for the charging process to be carried out, a first efficiency value can be determined for the direct coupling between the energy store and energy source or energy sink and, on the other hand, a second efficiency value can be determined for charging using the intermediate store. Depending on which efficiency value is higher, a decision can therefore be made as to whether charging is to be carried out using the intermediate store or by using only the intermediate store, or without using the intermediate store. This also applies in particular to a charging process in which the energy store of the motor vehicle is to be charged. However, the predetermined minimum value can also be different from zero. This means that even if the first efficiency value for direct coupling of the energy store to the energy source is slightly lower than the second efficiency value for a charging process using the intermediate store, a charging process can still be carried out without using the intermediate store or at least with additional direct coupling to the energy source, for example in order to protect the intermediate store with an only slightly reduced first efficiency value compared to the second efficiency value. This increases the lifetime of the intermediate store.

In addition, according to a further advantageous embodiment, it can be provided that the predetermined criterion comprises that the intermediate store is at least partially charged and in particular has a predetermined high state of charge for carrying out the charging process. However, it can also be provided that, as long as only a small amount of energy is stored in the intermediate store, the charging process can be carried out using the intermediate store. In other words, a specific minimum charging state of the intermediate store does not necessarily have to be reached in order to be able to carry out the charging process using the intermediate store. The charging parameters according to which the charging process is ultimately carried out can also change while the charging process is being carried out. Such charging parameters are, for example, the charging power value according to which charging is carried out, and also, for example, whether or not charging is carried out using the intermediate store. If the intermediate store is completely empty at some point during the charging process, for example, a switch can then be made to charging by means of direct coupling with the energy source. If, for example, the situation parameter changes during the charging process and this results in a different first and/or second efficiency value, it is also possible to switch between the two charging options using the intermediate store and without using the intermediate store. If the situation parameter or the value of the situation parameter changes while the charging process is being carried out, the charging power value according to which charging is carried out can also be changed based on the provided relationship. It is therefore also conceivable that, in order to carry out a charging process, the value of the situation parameter is not only recorded once, but also repeatedly during the charging process and based on this, for example, an updated charging power value is determined, according to which the charging process is continued. Thus, the efficiency during the charging process can be further increased.

In a further advantageous embodiment of the invention, a first value of the situation parameter is determined at a first point in time, a forecast for a future change over time of the first value of the situation parameter is determined and, depending on the forecast and in particular on the relationship, a future point in time for the start of the charging process is determined, and the charging process is started at the future point in time. This embodiment is particularly advantageous if the situation parameter is, for example, a temperature of the motor vehicle or a driving state of the motor vehicle. For example, if the motor vehicle has just been driven, its temperature is typically also higher than when the motor vehicle is stationary for a certain period of time. The temperature of the motor vehicle has a significant influence on the efficiency of a charging process. It is therefore usually advantageous to carry out the charging process at lower motor vehicle temperatures, because on the one hand a higher efficiency can be achieved and on the other hand the connection of certain consumers, such as cooling devices, can be avoided or reduced. This also saves energy. A time delay in the start of the charging process can thus advantageously also lead to an increase in efficiency. If a current situation, for example a currently high motor vehicle temperature, has a negative effect on the efficiency of the charging process, and it is to be expected that this situation will change in the future in such a way that the charging efficiency can be increased, a corresponding future point in time can be determined for the start of the charging process and the charging process can then advantageously be started at this future point in time.

It is also very advantageous if the future point in time is also determined as a function of a specified next time of use of the motor vehicle, in particular wherein the next time of use is predicted as a function of stored use data of the motor vehicle and/or is specified by a user. This embodiment comprising the determination of a future point in time for the start of the charging process to optimize efficiency is particularly advantageous if the user no longer wants to drive the motor vehicle in the near future. This can advantageously be specified by a corresponding user specification or user input. The user can therefore use a user interface, for example in the motor vehicle, to communicate when he wants to drive the motor vehicle next time, for example in how many hours or at what time. It would also be conceivable for the motor vehicle or the above-mentioned control device of the charging system to predict the next time of use on the basis of historical driving and usage data. If, for example, the motor vehicle is to be driven again in a short time, the charging process can be started without a time delay, provided charging of the energy store of the motor vehicle is required. If, for example, the vehicle is not to be driven until the next day, there is a certain amount of leeway with regard to the choice of the start time for the charging process, without reducing the user's comfort. Accordingly, it can then be checked whether the charging efficiency can be increased, namely the efficiency of the charging process can be increased, by not starting the charging process immediately, but by starting the charging process with a time delay. This can in turn be determined by using the first value of the situation parameter predicted for this future point in time and the provided relationship in order to determine a corresponding maximum possible efficiency therefrom. This can be compared, for example, with an efficiency determined for the current value of the situation parameter, and if this is higher, the charging process can accordingly only be started at a future point in time. However, the choice of the future point in time can also be determined in a different way: If, for example, the motor vehicle has just been driven and is now at a standstill and is connected to the intermediate store, and if according to a user specification of the next usage time of the motor vehicle, there is also sufficient time to delay the start of the charging process, one can first wait until the current motor vehicle temperature drops. It is possible to wait until the last possible point in time to ensure that the charging process is carried out completely until the next time of use, since without the motor vehicle being used in the meantime it is to be expected that the temperature of the motor vehicle will decrease steadily after use and will not increase. In order to improve such a forecast, an ambient temperature, in particular a current and/or forecast future temperature, can also be taken into account under certain circumstances. The charging process can also be started when there is no longer a significant decrease in the temperature of the motor vehicle or the temperature of the energy store over time. Incidentally, this applies not only when the energy store is being charged, but also when the energy store is being discharged in order to charge the intermediate store.

Since, as described, the charging efficiency is significantly influenced by the temperature, a further very advantageous embodiment of the invention consists in that the at least one situation parameter is a temperature, in particular an ambient temperature of an area surrounding the motor vehicle, a temperature of the motor vehicle and/or of the energy store, and/or a temperature of the intermediate store. Above all, taking into account the temperature of the motor vehicle or of the energy store is enormously advantageous, since this significantly influences the efficiency of the charging process. The ambient temperature can also be used and taken into account, especially for more precise predictions about future developments of the temperature of the motor vehicle and/or the energy store. Optionally, the temperature of the intermediate store can also be taken into account. Several situation parameters can also be provided and each of these situation parameters can be one of the temperatures mentioned. The various situation parameters and their influence on the efficiency, in particular for the respective charging power, can be stored accordingly in one or more characteristic diagrams. Depending on the situation, a charging process can always be carried out that is optimized in terms of its efficiency.

In a further advantageous embodiment of the invention, the at least one situation parameter or at least one second situation parameter represents at least one of the following: A type of current flow, in particular direct current or alternating current, between the energy store and the intermediate store or between the energy store and the energy source, a connection or charging power of the energy source, in particular of a domestic mains connection, the second charging power value that can currently be provided by a PV system as an energy source, an operating state of other consumers of the motor vehicle that are active during the charging process to be carried out, and/or a charging state and/or aging state of the energy store. In this way, advantageously, comprehensive additional information that is suitable for characterizing a current situation can be taken into account in order to determine the optimal charging strategy for optimizing the efficiency.

The invention also relates to a charging system for carrying out a charging process using an energy store in a motor vehicle, the motor vehicle being connectable to a intermediate store coupled to an energy source in order to carry out the charging process, and wherein the charging system has a control device with a memory. In this case, a relationship between at least one situation parameter, a charging power and an efficiency of the charging process is stored in the memory of the control device, and the control device is also designed to determine whether a charging process should be carried out using the intermediate store according to a predetermined criterion, to determine a first charging power value as a function of a determined value of the situation parameter and the relationship for optimizing the efficiency and at least, if the charging process is to be carried out using the intermediate store according to the predetermined criterion, to carry out the charging process by specifying the specific first charging power value, so that during the charging process electrical energy is transmitted between the intermediate store and the energy store of the motor vehicle with the charging power being according to the first charging power value.

The advantages described for the method according to the invention and its embodiments thus apply similarly to the charging system according to the invention. In this case, the control device preferably represents a control device external to the motor vehicle and in particular also external to the intermediate energy store. For example, the control device can be provided by a central data processing device, for example a backend server. This can communicate with the intermediate store and/or the motor vehicle, for example via the Internet or another wireless communication link, in order to exchange data with the motor vehicle and/or the intermediate store. Accordingly, the motor vehicle and/or the intermediate store can also be regarded as part of the charging system. The motor vehicle can be designed, for example, to determine the value of the situation parameter, in particular repeatedly. The motor vehicle can transmit the currently determined values to the control device or the backend server. From this, the latter can determine a suitable charging strategy for optimizing the efficiency during the charging process to be carried out, in particular a charging power which is optimized in terms of efficiency or a corresponding charging power value. This can then in turn be transmitted to the motor vehicle and the motor vehicle can carry out the charging process according to the charging power value specified by the control device. However, it would also be conceivable for the control device to be part of the motor vehicle itself.

The charging system is generally designed to carry out a method according to the invention or one of its embodiments.

The control device for the charging system also belongs to the invention. The control device can have a data processing device or a processor device which is set up to perform an embodiment of the method according to the invention. For this purpose, the processor device can have at least one microprocessor and/or at least one microcontroller and/or at least one FPGA (Field Programmable Gate Array) and/or at least one DSP (Digital Signal Processor). The processor device can also have program code provided for performing the embodiment of the method according to the invention when performed by the processor device. The program code can be stored in a data memory of the processor device. A processor circuit of the processor device can have, for example, at least one circuit board and/or at least one SoC (System on Chip).

The invention also includes developments of the charging system according to the invention, which comprise features which have already been described in conjunction with the developments of the method according to the invention. For this reason, the corresponding developments of the method according to the invention are not described again here.

As a further solution, the invention also comprises a computer-readable storage medium, comprising instructions which, when executed by a computer or a computer network, cause it to execute an embodiment of the method according to the invention. The storage medium can be embodied, for example, at least partially as a non-volatile data memory (such as a flash memory and/or as an SSD—solid state drive) and/or at least partially as a volatile data memory (such as a RAM-random access memory). However, the storage medium can also be operated, for example, as a so-called app store server on the Internet. A processor circuit with at least one microprocessor can be provided by the computer or computer network. The commands can be provided as binary code or assembler and/or as source code of a programming language (such as C).

The invention also comprises the combinations of the features of the described embodiments. The invention thus also comprises implementations each comprising a combination of the features of a plurality of the described embodiments, provided that the embodiments were not described as mutually exclusive.

### BRIEF DESCRIPTION OF THE FIGURES

Exemplary embodiments of the invention are described hereinafter. In particular:

FIG. 1 shows a schematic representation of the execution of a charging process according to an example not belonging to the invention;

FIG. 2 shows a schematic representation of the execution of a charging process for charging an energy store of a motor vehicle by means of an intermediate store according to an exemplary embodiment of the invention;

FIG. 3 shows a schematic representation of the execution of a discharging process of an energy store of a motor vehicle according to an example not belonging to the invention; and

FIG. 4 shows a schematic representation of the execution of a charging process for charging an intermediate store by means of an energy store according to an exemplary embodiment of the invention;

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

The nominal values listed below for illustration purposes, in particular temperature values, power values and efficiency values, are for the purpose of understanding and do not represent any specific measurement results or similar.

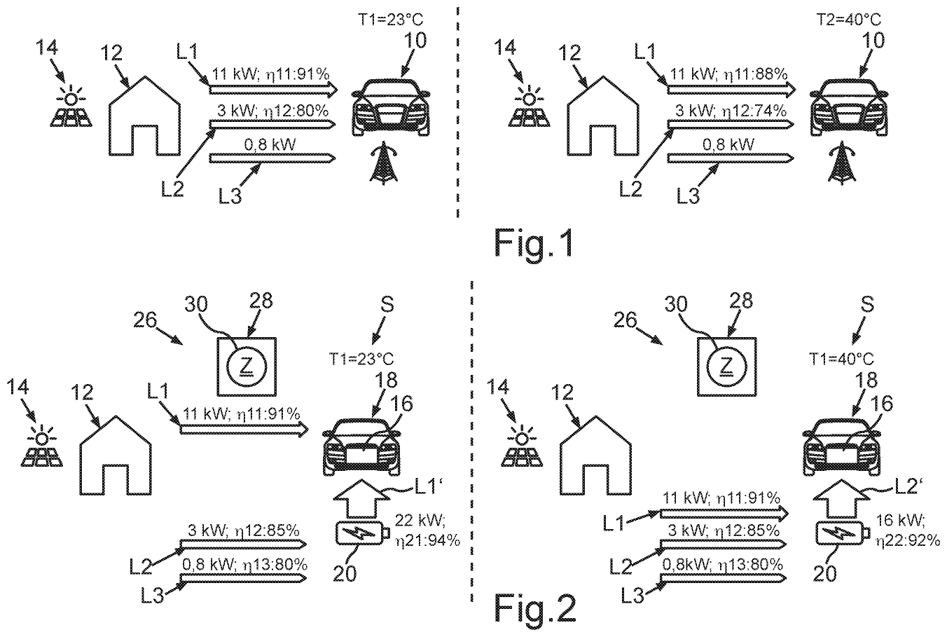

FIG. 1 shows a schematic representation of a charging process for charging an energy store of a motor vehicle 10 according to an example not belonging to the invention. In this example, a house or household 12 is shown with a photovoltaic system 14, via which the motor vehicle 10 can be charged. FIG. 1 shows this charging process in particular on the left-hand side for a first temperature T1 of motor vehicle 10 equal to 23 degrees Celsius and on the right-hand side for a second temperature T2 of 40 degrees Celsius. Depending on the position of the sun, the photovoltaic system 14 can provide different charging powers or, to be more precise, different charging power values L1, L2, L3, for example 11 kilowatts in case of sunshine, 3 kilowatts in light clouds and 0.8 kilowatts on a very cloudy day. Depending on the design of motor vehicle 10, different first efficiencies η11, η12 also result for different charging powers L1, L2, L3. For example, the motor vehicle 10 can be charged with a charging power of 11 kilowatts with an efficiency η11 of 91 percent, and with a charging power L2 of 3 kilowatts with an efficiency η12 of 80 percent. Charging the motor vehicle 10 typically does not make sense with charging powers of significantly less than one kilowatt, since in this case the efficiency of the charging process is too low or the losses or consumption of the infrastructure and/or vehicle associated with the charging are too high. The charging process can take ten hours, for example. As shown on the right in FIG. 1, depending on the temperature, in particular for the second temperature value T2 of 40 degrees Celsius, there are other first efficiencies η11, η12, namely 88 percent for the first charging power L1 of 11 kilowatts and 74 percent for the second charging power L2 of 3 kilowatts. In this example, too, the charging time can be ten hours.

This is intended to illustrate that depending on the situation, namely the charging power that can be provided and other situation parameters, such as the current motor vehicle temperature, the efficiency of a charging process can vary extremely. It is therefore possible that such a charging process can be very inefficient and comparatively expensive.

The invention or its embodiments now advantageously make it possible to increase the efficiency of a charging process, as will now be explained in more detail with reference to FIG. 2.

FIG. 2 shows a schematic representation of a charging process for charging an energy store 16 of a motor vehicle 18 by means of an intermediate store 20 according to an exemplary embodiment of the invention; The intermediate store 20 is in turn connected to an energy source 22, which in this example is in turn provided by a PV system 22, in particular of a house 24 or household 24. The intermediate store 20 can be charged via the energy source 22 as well as by the mains supply that is provided by the infrastructure of the house.

Because an intermediate store 20 can now advantageously be used to charge the energy store 16 of the motor vehicle 18, one is no longer bound to predetermined charging powers L1, L2, L3, which can currently be provided by the energy source 22, for example. In principle, the charging power L1′ that can be used to charge the energy store 16 can now advantageously be flexibly selected or adjusted. This now advantageously makes it possible to select a charging power L1′ that is adapted to the situation and that optimizes the second efficiency η21, η22 of this charging process via the intermediate store 20. This charging power value L1′ is determined by a charging system 26 according to an exemplary embodiment of the invention.

The charging system 26 can in turn comprise a control device 28 which, in this example, is designed as a control device 28 external to the motor vehicle and also external to an intermediate energy store, for example as part of a backend server. This control device 28 can, for example, have a memory 30 with a relationship Z stored therein between at least one situation parameter S, the charging power and the efficiency. The situation parameter S is preferably at least a current temperature of the motor vehicle 18 or the energy store 16, wherein this situation parameter S in the illustration on the left in FIG. 2 again assumes a first temperature value T1 of 23 degrees Celsius. Depending on this temperature value T1, for example, the control device 28 can determine the charging power L1′ with which a maximum efficiency η2 can be achieved. The motor vehicle 18 or its energy store 16 can then be charged via the intermediate store 20 with this determined charging power L1′, in this example 22 kilowatts, wherein an efficiency η21 of 94 percent can be achieved for the current temperature T1 of 23 degrees Celsius. As a result, the efficiency can advantageously be significantly increased. Since it is possible to charge with a significantly higher charging power L1′, the charging process can also be carried out in an extremely short time of 0.2 hours, for example.

In addition, it can be provided that the energy store 16 can also be simultaneously charged directly by the energy source 22. This charging can take place at the same time as charging through the intermediate store 20. In addition, whether direct charging is carried out via the energy source 22 or not can depend on how high the charging power L1, L2, L3 that can currently be provided by the energy source 22 is, and what efficiency η11, η12, η13 can be achieved as a result. If this efficiency is too low or is below a specific threshold value, direct charging via the photovoltaic system 22 can be dispensed with and instead the intermediate store 20 can be fed via the photovoltaic system 22. If the efficiency η11, η12, η13 is sufficiently high, the energy store 16 can also be charged via the photovoltaic system 22, in particular either in addition to the intermediate store 20, as shown here, or also alone and without using the intermediate store 20. Additional energy losses through the intermediate storage can thereby be avoided and the intermediate store 20 can also be protected. Overall, this provides a particularly high degree of flexibility in order to optimize the efficiency.

FIG. 2 shows the same charging system 26 on the right-hand side, but in a different situation, in particular for a second temperature value T2 of 40 degrees Celsius, wherein also in this case the vehicle temperature represents the situation parameter S, which is used by the control device 28 to determine an optimal, i.e. an efficiency-optimizing charging power L2′.

In this example, based on the relationship Z and the current value T2 of the situation parameter S2, the control device 28 has determined a second charging power value L2′ of 16 kilowatts as the optimal charging power value L2′ for maximizing the efficiency η22. In this example, the energy store 16 is charged exclusively via the intermediate store 20, since the high temperature of 40 degrees Celsius would result in significantly lower efficiencies η11, η12, η13 for direct charging using the photovoltaic system 22, in particular of 91 percent with a charging power L1 of 11 kilowatts, an efficiency η12 of 85 percent with a second charging power L2 of 3 kilowatts, and an efficiency η13 of 80 percent with a charging power L3 of 0.8 kilowatts. Instead, the energy that can currently be provided by the photovoltaic system 22 is used to recharge the intermediate store 20. Due to the lower charging power L2′ of 16 kilowatts, the charging time is extended to 0.3 hours compared to the example shown on the left. Overall, when charging the energy store 16, a higher efficiency η22 can still be provided than would be possible via direct coupling to the photovoltaic system 22. In addition, by using the intermediate store 20 it is always possible to charge the energy store 16 of the motor vehicle 18, even if only a very low charging power or no charging power at all is temporarily provided by the photovoltaic system 22.

Although not shown here either, the intermediate store 20 can be charged not only by a regenerative energy source 22, but also, for example, exclusively or additionally by drawing electricity from the mains.

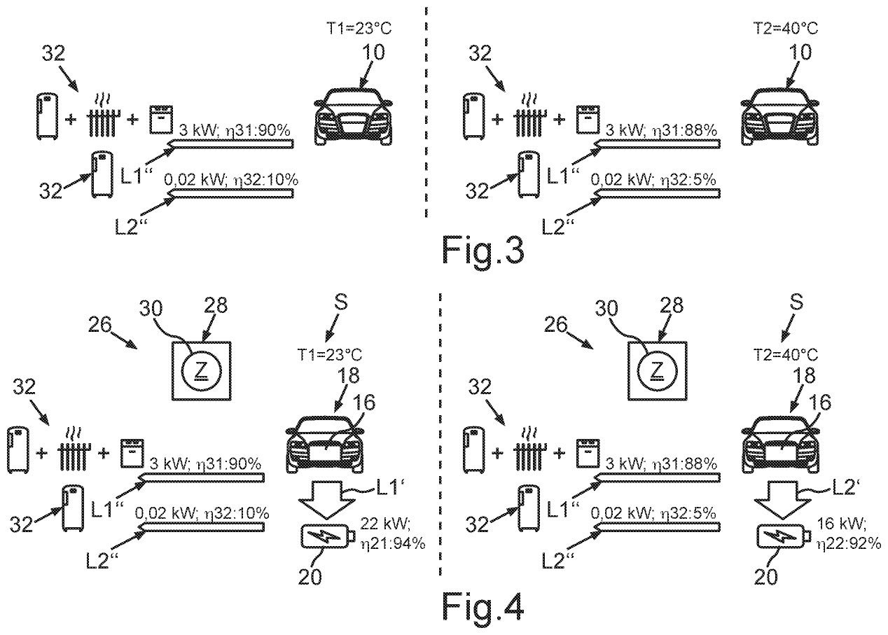

FIG. 3 shows a schematic representation of a charging process for charging an energy store of a motor vehicle 10 according to an example not belonging to the invention. In this example, the energy store of motor vehicle 10 is not to be charged, but instead various consumers 32 are to be supplied with energy from the energy store of the motor vehicle 10 in the context of bidirectional charging. A situation is again shown on the left in which the motor vehicle has a temperature T1 of 23 degrees Celsius, and on the right a temperature T2 of 40 degrees Celsius. Depending on the supply power L1″, L2″ currently required by consumers 32, different third efficiencies η3 also result here for this discharging process of the energy store of motor vehicle 10 to supply these consumers 32. If, for example, many consumers 32 are active at the same time, they require a higher supply power L1″ in this example of 3 kilowatts, for which an efficiency η31 of 90 percent results, and if only a few of these consumers 32 are active, they accordingly require a lower supply power L2″ of 0.02 kilowatts in this example, resulting in an efficiency η32 of 10 percent. These efficiencies η31, η32 are also dependent on the current temperature, so that in the example on the right, at a second temperature T2 of 40 degrees Celsius, other efficiencies η31 and η32 of 88 percent and 5 percent respectively result. In this example, the discharge time can be 0.2 hours at a temperature of 23 degrees Celsius and 0.3 hours at a temperature of 40 degrees Celsius.

Depending on the situation and the required power supply, the efficiencies in this example are thus extremely low. A further disadvantage of this type of bidirectional charging is that the motor vehicle 10 may have to be woken up constantly, depending on when consumers 32 need energy in order to provide this energy from the energy store of the vehicle 10. This puts an additional load on the energy store and reduces its service life. Other electronic components of the vehicle 10 are also heavily stressed as a result.

These disadvantages, too, can now advantageously be at least mitigated by the invention or its embodiments. FIG. 4 shows a schematic illustration of a charging system according to an exemplary embodiment of the invention. This can be designed in particular as already described in relation to FIG. 2 and is used here in particular for bidirectional charging of consumers 32. The consumers 32 can represent consumers of a household, for example the household 24 mentioned above. The discharging of the energy store 16 via the intermediate store 20 thus ultimately serves to supply power to the house. In this case, too, the intermediate store 20 is used again, as a result of which the overall efficiency can be significantly increased. For example, the control device 28 can select a corresponding discharge power L1′ at a vehicle temperature T1 of 23 degrees, in this example 22 kilowatts, or a corresponding discharge power L2′ at a vehicle temperature T2 of 40 degrees, in this example 16 kilowatts, which for the current situation, which can be characterized by the situation parameter S, leads to the highest possible efficiency η21, in this example 94 percent at a vehicle temperature T1 of 23 degrees, or η22, in this example 92 percent at a vehicle temperature T2 of 40 degrees. The situation with a vehicle temperature T1 of 23 degrees Celsius is shown on the left-hand side of FIG. 4, and for 40 degrees Celsius on the right-hand side of FIG. 4. The consumers 32 can then be supplied with the energy stored in the intermediate store 20. The respective supply powers L1″ and L2″ are consequently no longer provided directly by the energy store 16 of the vehicle 18, but via the intermediate store 20. Although certain power losses are present in this case, this procedure has numerous advantages: on the one hand, the wake-up cycles of the vehicle 18 can be reduced to a minimum, in particular in favor of longer charging times for charging the intermediate store 20 by the energy store 16. This is gentler both for the energy store 16 and for the intermediate store 20 and extends their service life. Another great advantage is the possibility of temporal decoupling between the charging of the intermediate store 20 by energy store 16 and the supply of consumers 32. If, for example, the motor vehicle 18 has been driven recently and the vehicle temperature is therefore very high, for example, it can be waited until this temperature has dropped in order to charge the intermediate memory 20, so that ultimately a significantly higher efficiency can be achieved during the charging process for charging the intermediate store 20 by the energy store 16 of the motor vehicle 18.

Overall, the examples show how smart impulse charging can be provided by the invention, according to which vehicles can be efficiently charged using smart impulse charging in situations in which there are coordinated vehicle battery ecosystems. The underlying charging and discharging algorithm, which can be implemented by the above-mentioned control device, takes into account as many as possible, in particular all, influencing factors that have positive or negative effects on efficiency and accordingly regulates the charging power to the efficiency optimum. For example, efficiency determines whether the charging power in a PV excess charging situation is sufficient to immediately charge a connected battery-electric vehicle, or whether, taking into account any further efficiency losses, a detour is chosen via the battery storage integrated into the ecosystem, which was also referred to as intermediate store in this case. As a result, battery-electric vehicles in particular can be charged in an efficiency-optimized manner with a different and usually higher charging power from the self-sufficient store, namely the intermediate store. The same charging logic is used in the opposite direction if the vehicle or its battery is to be used in the “V2L”, “V2H” or “V2G” context. Here, too, the corresponding current overall context determines the efficiency-optimal charging power. In addition to charging efficiency, Smart Impulse Charging also optimizes other factors such as the number of wake-up cycles or the duration of the charging process. For example, the vehicle design can be optimized with regard to the discharge time in the case of bidirectional charging, and through higher discharge powers in the intermediate store the discharge time is decoupled from the actual provision of energy, since this is now taken over by the intermediate store.

1. A method for carrying out a charging process using an energy store of a motor vehicle, wherein the motor vehicle can be connected to an intermediate store coupled to an energy source and/or to an energy sink in order to carry out the charging process, wherein
a relationship between at least one situation parameter, a charging power and an efficiency of the charging process is provided;
a value of the situation parameter is determined;
it is determined whether a charging process should be carried out using the intermediate store according to a predetermined criterion; and
at least if the charging process is to be carried out using the intermediate store according to the predetermined criterion, a charging process is carried out in which electrical energy is transmitted between the intermediate store and the energy store of the motor vehicle with the charging power according to a first charging power value, which was determined as a function of the specific value of the situation parameter and the relationship in order to optimize the efficiency.

2. The method according to claim 1, wherein during the charging process, the energy is transferred from the intermediate store to the energy store and the energy store is thereby charged.

3. The method according to claim 1, wherein during the charging process, the energy is transferred from the energy store to the intermediate store and the intermediate store is thereby charged.

4. The method according to claim 1, wherein a consumer representing the energy sink is coupled to the intermediate store and the consumer is charged by energy from the intermediate store.

5. The method according to claim 1, wherein the predetermined criterion according to which it is checked whether a charging process should be carried out using the intermediate store, in particular only using the intermediate store, comprises
that a first efficiency value for the charging process to be carried out with direct coupling of the energy store to the energy source or the energy sink is determined as a function of at least one situation parameter, the relationship and in particular a second charging power value specified by the energy source or the energy sink is determined and if this first efficiency value falls below a predetermined limit value, the predetermined criterion is considered to be met; and/or
that a first efficiency value for the charging process to be carried out with direct coupling of the energy store to the energy source or the energy sink is determined as a function of at least one situation parameter, the relationship and in particular a charging power value determined by the energy source or the energy sink, and is compared with a second efficiency value, which is assigned to the charging process with the determined first charging power value by means of the intermediate store according to relationship, and the predetermined criterion is considered to be met if the first efficiency value is smaller by a predetermined minimum value than the second efficiency value; and/or
that the intermediate store is at least partially charged and in particular has a predetermined high state of charge for carrying out the charging process.

6. The method according to claim 1, wherein a first value of the situation parameter is determined at a first point in time, a forecast for a future change over time of the first value of the situation parameter is determined and, as a function of the forecast and in particular of the relationship, a future point in time for the start of the charging process is determined, and the charging process is started at the future point in time.

7. The method according to claim 1, wherein the future point in time is also determined as a function of a specified next time of use of the motor vehicle, in particular wherein the next time of use is predicted as a function of stored usage data of the motor vehicle and/or is specified by a user input.

8. The method according to claim 1, wherein the at least one situation parameter is a temperature, in particular
an ambient temperature of an environment of the motor vehicle;
a temperature of the motor vehicle and/or of the energy store;
a temperature of the intermediate store.

9. The method according to claim 1, wherein the at least one situation parameter or at least one second situation parameter represents at least one of the following:
a type of current flow, in particular direct current or alternating current, between the energy store and the intermediate store or the energy source;
a connection or charging power of the energy source, in particular of a domestic power supply connection;
the second charging power value that can currently be provided by a PV system as the energy source;
an operating state of further consumers of the motor vehicle that are active during the charging process to be carried out;
a state of charge and/or aging state of the energy store.

10. A charging system for carrying out a charging process using an energy store of a motor vehicle, wherein the motor vehicle is connectable to an intermediate store coupled to an energy source in order to carry out the charging process, wherein the charging system has a control device with a memory,
wherein a relationship between at least one situation parameter, a charging power and an efficiency of the charging process is stored in the memory of the control device, and the control device is designed for
determining, whether a charging process should be carried out using the intermediate store according to a predetermined criterion,
determining a first charging power value as a function of a determined value of the situation parameter and the relationship for optimizing the efficiency, and
at least if the charging process is to be carried out using the intermediate store according to the predetermined criterion, triggering the execution of the charging process by specifying the specific first charging power value, so that during the charging process electrical energy is transmitted between the intermediate store and the energy store of the motor vehicle with the charging power according to the first charging power value.

11. The method according to claim 2, wherein during the charging process, the energy is transferred from the energy store to the intermediate store and the intermediate store is thereby charged.

12. The method according to claim 2, wherein a consumer representing the energy sink is coupled to the intermediate store and the consumer is charged by energy from the intermediate store.

13. The method according to claim 3, wherein a consumer representing the energy sink is coupled to the intermediate store and the consumer is charged by energy from the intermediate store.

14. The method according to claim 2, wherein the predetermined criterion according to which it is checked whether a charging process should be carried out using the intermediate store, in particular only using the intermediate store, comprises
that a first efficiency value for the charging process to be carried out with direct coupling of the energy store to the energy source or the energy sink is determined as a function of at least one situation parameter, the relationship and in particular a second charging power value specified by the energy source or the energy sink is determined and if this first efficiency value falls below a predetermined limit value, the predetermined criterion is considered to be met; and/or
that a first efficiency value for the charging process to be carried out with direct coupling of the energy store to the energy source or the energy sink is determined as a function of at least one situation parameter, the relationship and in particular a charging power value determined by the energy source or the energy sink, and is compared with a second efficiency value, which is assigned to the charging process with the determined first charging power value by means of the intermediate store according to relationship, and the predetermined criterion is considered to be met if the first efficiency value is smaller by a predetermined minimum value than the second efficiency value; and/or
that the intermediate store is at least partially charged and in particular has a predetermined high state of charge for carrying out the charging process.

15. The method according to claim 3, wherein the predetermined criterion according to which it is checked whether a charging process should be carried out using the intermediate store, in particular only using the intermediate store, comprises
that a first efficiency value for the charging process to be carried out with direct coupling of the energy store to the energy source or the energy sink is determined as a function of at least one situation parameter, the relationship and in particular a second charging power value specified by the energy source or the energy sink is determined and if this first efficiency value falls below a predetermined limit value, the predetermined criterion is considered to be met; and/or
that a first efficiency value for the charging process to be carried out with direct coupling of the energy store to the energy source or the energy sink is determined as a function of at least one situation parameter, the relationship and in particular a charging power value determined by the energy source or the energy sink, and is compared with a second efficiency value, which is assigned to the charging process with the determined first charging power value by means of the intermediate store according to relationship, and the predetermined criterion is considered to be met if the first efficiency value is smaller by a predetermined minimum value than the second efficiency value; and/or
that the intermediate store is at least partially charged and in particular has a predetermined high state of charge for carrying out the charging process.

16. The method according to claim 4, wherein the predetermined criterion according to which it is checked whether a charging process should be carried out using the intermediate store, in particular only using the intermediate store, comprises
that a first efficiency value for the charging process to be carried out with direct coupling of the energy store to the energy source or the energy sink is determined as a function of at least one situation parameter, the relationship and in particular a second charging power value specified by the energy source or the energy sink is determined and if this first efficiency value falls below a predetermined limit value, the predetermined criterion is considered to be met; and/or
that a first efficiency value for the charging process to be carried out with direct coupling of the energy store to the energy source or the energy sink is determined as a function of at least one situation parameter, the relationship and in particular a charging power value determined by the energy source or the energy sink, and is compared with a second efficiency value, which is assigned to the charging process with the determined first charging power value by means of the intermediate store according to relationship, and the predetermined criterion is considered to be met if the first efficiency value is smaller by a predetermined minimum value than the second efficiency value; and/or
that the intermediate store is at least partially charged and in particular has a predetermined high state of charge for carrying out the charging process.

17. The method according to claim 2, wherein a first value of the situation parameter is determined at a first point in time, a forecast for a future change over time of the first value of the situation parameter is determined and, as a function of the forecast and in particular of the relationship, a future point in time for the start of the charging process is determined, and the charging process is started at the future point in time.

18. The method according to claim 3, wherein a first value of the situation parameter is determined at a first point in time, a forecast for a future change over time of the first value of the situation parameter is determined and, as a function of the forecast and in particular of the relationship, a future point in time for the start of the charging process is determined, and the charging process is started at the future point in time.

19. The method according to claim 4, wherein a first value of the situation parameter is determined at a first point in time, a forecast for a future change over time of the first value of the situation parameter is determined and, as a function of the forecast and in particular of the relationship, a future point in time for the start of the charging process is determined, and the charging process is started at the future point in time.

20. The method according to claim 5, wherein a first value of the situation parameter is determined at a first point in time, a forecast for a future change over time of the first value of the situation parameter is determined and, as a function of the forecast and in particular of the relationship, a future point in time for the start of the charging process is determined, and the charging process is started at the future point in time.
